(19) United States
(12) Patent Application Publication
(10) Pub. No.: US 2025/0297886 A1
(43) Pub. Date: Sep. 25, 2025

(54) LOAD CELL WEIGHING AND DRIFT DETECTION IN A ELECTRONIC SCALE SYSTEM

(71) Applicant: SCALE TEC, LTD., Anamosa, IA (US)

(72) Inventors: Nicholas VON MUENSTER, Anamosa, IA (US); Dan SECRIST, Anamosa, IA (US)

(21) Appl. No.: 19/055,134

(22) Filed: Feb. 17, 2025

Related U.S. Application Data
(60) Provisional application No. 63/567,280, filed on Mar. 19, 2024.

(51) Int. Cl. G01G 23/01; A01D 90/12; G01G 19/08

(52) U.S. Cl. CPC G01G 23/01; A01D 90/12; G01G 19/08

(57) ABSTRACT

Microprocessor for a scale system for a mobile storage carrier operates in three states: motion, stable, and fault where stability is determined based on load cell signal variations or external sources and a fault state follows a stable state in response to signal drift in one or more load cells.

### CROSS-REFERENCE TO RELATED APPLICATIONS

The present application claims the benefit of U.S. Provisional Patent Application No. 63/567,280 filed Mar. 19, 2024, the entirety of which is incorporated herein by reference.

### TECHNICAL FIELD

The present disclosure relates to scale systems in agricultural applications, and, more specifically, this disclosure relates to the detecting faulty or malfunctioning load cells in a mobile scale system.

### BACKGROUND INFORMATION

Electronic, mobile scale systems, including scale controllers and load cells, are widely used in agricultural applications to facilitate the weighing of materials such as feed, seed, grain, and fertilizers. These systems enhance efficiency and accuracy in material handling operations, contributing to improved farm management and profitability. Load cells, as core components of electronic, mobile scale systems, convert mechanical force into electrical signals to provide precise weight measurements.

Agricultural environments present harsh conditions that can adversely affect the performance and longevity of mobile scale systems. Load cells and associated electronic components are frequently exposed to moisture, temperature fluctuations, dust, and mechanical stress. Common issues include moisture intrusion leading to corrosion, physical damage to load cells and cabling, and failure of strain gauges or other sensor elements. These environmental factors increase the likelihood of system malfunctions, reducing farm efficiency until repairs or replacements are made.

FIG. 1 illustrates a prior art electronic scale system 100 and its components. A conventional scale indicator 101 includes an integrated controller with a visual display for weight readouts and a user interface for system interactions. The scale indicator 101 communicates with multiple weight-measuring sensors, typically implemented as load cells affixed to storage carriers such as grain carts or hopper bodies. The system can measure discrete weight values at a given time or track weight changes over time during material loading and unloading.

In prior systems, a junction box 102 is commonly used to aggregate signals from multiple load cells 103. This junction box collects and combines analog signals from the connected load cells, transmitting a single processed signal to the scale indicator 101. However, this approach presents significant diagnostic challenges. Because individual load cell signals are merged, identifying faults in specific system components requires manually disconnecting and testing each load cell separately. This process can be time-consuming and necessitates specialized technical expertise.

Reducing the time and effort required for fault diagnosis would provide a significant advantage over existing agricultural scale systems. Traditional systems also struggle with signal noise introduced by the movement of mobile storage carriers, making it difficult to collect reliable data during operation. Advancements in scale system technology that improve diagnostic capabilities and enhance data accuracy in dynamic conditions would be highly beneficial for agricultural applications.

### SUMMARY

The present invention relates to a scale system for a mobile storage carrier, such as a grain cart, which incorporates load cell fault detection and compensation to ensure accurate weight measurement. The system includes a plurality of load cells mounted on the storage carrier to detect weight changes based on mechanical deformations. Each load cell generates an analog output signal, which is converted into a digital output signal by a multi-channel analog-to-digital converter (ADC). These digital signals are processed by a microprocessor, which classifies the system into one of three states: (1) Motion State—The mobile storage carrier is in motion; (2) Stable State—The mobile storage carrier is at rest with stable load cell signals; and (3) Fault State—The system detects a drift beyond a predefined threshold in at least one load cell when at rest, indicating a malfunction.

In an embodiment, the microprocessor determines the stable state based on variations in the digital output signals of the load cells. If a sufficient number of load cells remain within an acceptable threshold (e.g., as x out of n load cells, where n/2<x<n−1), the system confirms stability. Additionally, stability can be determined using external sources, such as GPS, velocity sensors, accelerometers, or vehicle signals.

In an embodiment, to enhance system performance, an artificial intelligence (AI) module is integrated to analyze the collected load cell data while in the stable state. In the event of a fault, the AI module can generate and supply a simulated signal to replace the faulty load cell's output, allowing the system to continue providing accurate weight measurements despite a detected failure.

In another embodiment, a method for detecting load cell faults is disclosed. The method can follow a structured process of: (1) Receiving and converting load cell signals; (2) Determining motion, stability, or fault conditions; and (3) Using AI-based data analysis and fault compensation to improve reliability.

In yet another embodiment, a scale controller can be coupled to a plurality of load cells on a mobile storage. The scale controller comprises of (i) a motion state based on fluctuating signals from the plurality of load cells; (ii) a stable state based on stable signals from a sufficient number of the plurality of load cells, wherein fluctuating signals from the remaining load cell or cells of the plurality of load cells is indicative of a malfunction in those cell(s); and (iii) a fault state based on excessive drift of a signal from at least one of the plurality of load cells when the microprocessor is in the stable state.

In an embodiment, the scale controller transitions between the motion state, stable state, and fault state based on predefined conditions, comprising: (i) transitioning from the stable state to the motion state when an external motion signal is received indicating movement of the mobile storage or when fluctuating signals from the plurality of load cells exceed a predefined variability threshold; (ii) transitioning from the motion state to the stable state when the external motion signal indicates that the mobile storage has stopped moving and the signals from the plurality of load cells remain stable below the predefined variability threshold for a predetermined duration; (iii) transitioning from the stable state to the fault state when at least one of the plurality of load cells exhibits excessive drift beyond a predefined drift threshold while the scale controller is in the stable state; (iv) transitioning from the stable state to the fault state when a sufficient number of the plurality of load cells remain stable while at least one other load cell exhibits fluctuating signals such that the number of stable load cells is greater than n/2 and less than n−1, where n represents a total number of the plurality of load cells; and (v) transitioning from the fault state to the stable state upon operator intervention or a system reset to clear the fault condition.

### BRIEF DESCRIPTION OF THE DRAWINGS

These and other features and advantages of the present invention will be better understood by reading the following detailed description, taken together with the drawings wherein:

FIG. 1 is prior art depiction of the components of an electronic scale system with a scale indicator, junction box, and load cells.

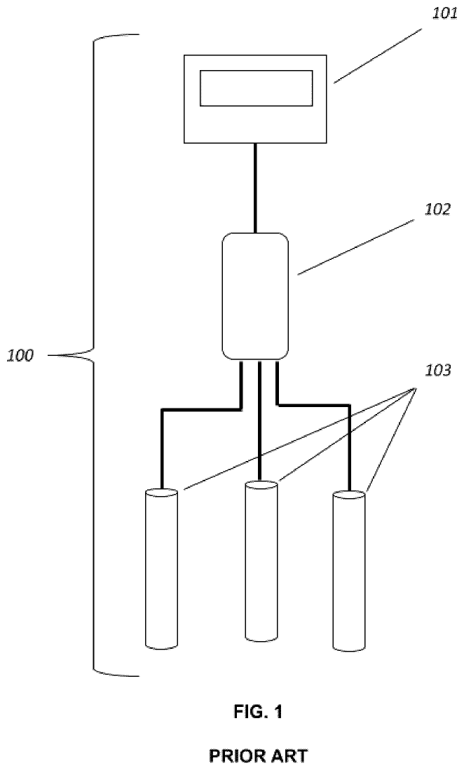

FIG. 2 shows a storage carrier with a weighing system according to this disclosure.

FIG. 3 is a block diagram of a scale controller according to this disclosure.

FIG. 4 is a state diagram according to this disclosure.

### DETAILED DESCRIPTION OF THE PREFERRED EMBODIMENTS

Disclosed is a scale system 200 for a storage carrier with load cell fault detection. Scale system 200 determines when storage carrier 101 is at rest and not in motion (i.e., the load cells are stable) by independently analyzing signals from each of a plurality of load cells 203 mounted on storage carrier 101. In the stable state, scale system 200 can detect malfunctioning load cells 203 when the storage carrier 101 by identifying absent, erratic or drifting signals indicative of failure.

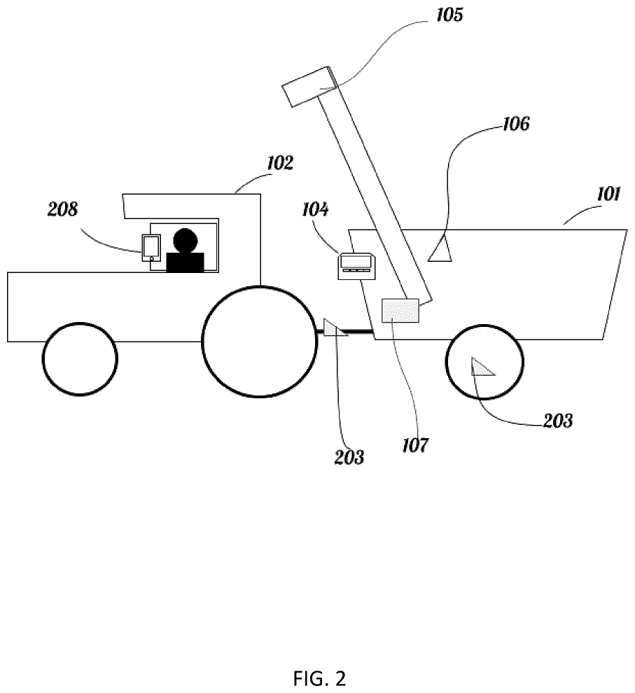

In one embodiment, scale system 200 is implemented on a storage carrier 101 configured as a grain cart, as shown in FIG. 2. For the purposes of this disclosure, a storage carrier 101 refers to any machine or container capable of holding and transporting material, including but not limited to combines, harvesters, mobile hoppers, wagons, and grain carts. Unless explicitly stated otherwise, the described embodiments apply to any such storage carriers. Storage carrier 101 may include an unloading apparatus 105, such as an auger or conveyor system, to facilitate material transfer. The unloading apparatus 105 may extend over another storage carrier 101, such as a semi-trailer, to enable controlled unloading.

The storage compartment of the storage carrier 101 can be configured as a hopper with a downward taper to direct material toward a hopper door 107, which may be actuated mechanically, hydraulically, or electrically. Opening the hopper door 107 allows for controlled discharge of material. An unloading apparatus 105, powered by a power take-off (PTO) shaft from a tractor 102, transfers material from the storage carrier 101 to another storage unit. The storage carrier 101 is equipped with multiple load cells 203 for real-time weight measurement. A scale controller 210, according to this disclosure, continuously monitors the material's weight, and additional sensors can be integrated into the scale system 200 to enhance material tracking and identification.

Load cells 203 herein described are transducers that converts mechanical force into an electrical signal proportional to the applied load. Load cells 203 measure weight for accurate load tracking, optimizing transport efficiency, and preventing overloading. Load cells 203 can include strain gauge load cells, such as shear beam, bending beam, canister, and S-beam configurations, which provide high accuracy and durability in harsh environments; hydraulic load cells, or digital load cells integrated into onboard electronics for real-time data processing and seamless connectivity with tractor displays or farm management systems via CANBUS, RS232, or ISOBUS. Load cells 203 can be installed in axles, undercarriages, hitches, or frame of storage carrier 101.

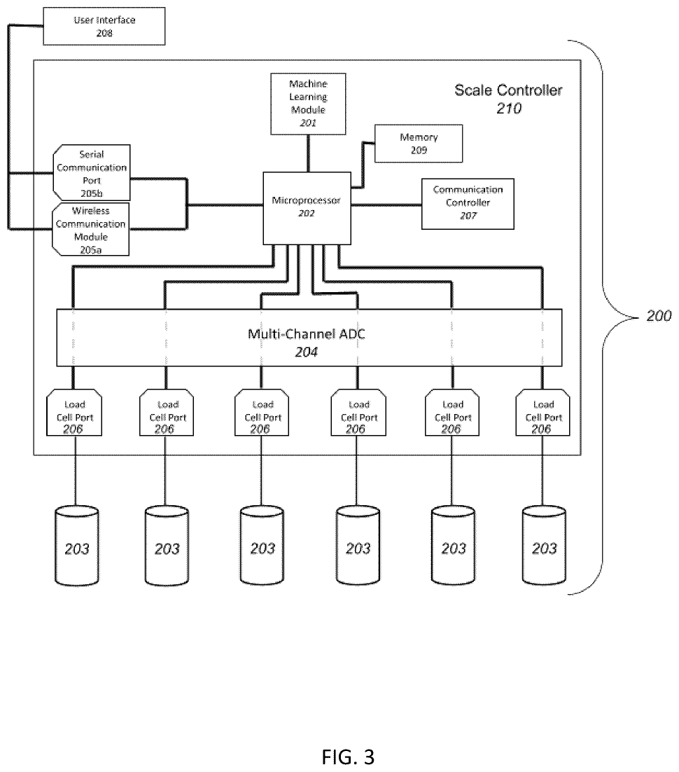

FIG. 3 shows a scale system 200 comprising of a scale controller 210 in communication with a user interface 208 and a plurality of load cells 203. Scale controller 210 converts each analog output signal from load cells 203 to a digital output signal using a multi-channel analog to digital converter (ADC) 204. ADC 204 is connected between a microprocessor 202 and a plurality of load cell ports 206 each individually connected to a corresponding one of plurality of load cells 203. This arrangement allows for the analog signal from each load cell port 206 to be received, analyzed, and interpreted individually by microprocessor 202.

Scale controller 210 is comprised of individual connections to each load cell 203 through corresponding load cell ports 206 for the purpose of receiving analog output signals from corresponding load cells 103. Scale controller 210 can be implemented on one or more printed circuit boards with embedded microprocessor 202, analog to digital conversion through ADC 204, which supports multiple simultaneous channels of analog signals, and communication controller 207. ADC 204 has multiple channels corresponding to each load cell 203 and provides a total of one conversion channel per load cell port 206. Microprocessor 202 can combine, isolate, diagnose, and alter the converted digital signals.

Scale controller 210 includes a memory partition 209 configured to record and store digital weight data from individual load cells 203, as well as the gross weight measured by the scale system 200. The memory partition 209 enables both real-time data processing and historical data storage for analysis and diagnostics. The recorded data can include: (i) Individual Load Cell Readings—The system logs weight values from each load cell 203, allowing for precise monitoring of load distribution; (ii) Gross Weight Measurements—The total weight of the material within the storage carrier 101 is continuously calculated and stored for display and transmission; (iii) Time-Stamped Data Logs—Each weight measurement is stored with a corresponding timestamp, enabling tracking of weight changes over time; (iv) Load Cell Status Information—The system records operational status and any detected faults in individual load cells 203, including erratic readings, signal drift, or loss of signal; and (v) System Calibration Data—Calibration coefficients and sensor offsets are stored to maintain long-term measurement accuracy and facilitate recalibration if necessary. The memory partition 209 can be implemented using non-volatile storage, such as flash memory, ensuring data retention even in the event of a power failure.

Additionally, the scale system 200 may support is communicatively coupled to a user interface 208. User interface 208 can be implemented with an integrated digital display or remotely from communication port 205 via a wired connection, e.g., an RS232 serial communication interface, or a wireless connection with the signals broadcast to a compatible user interface 208, such as one implemented as a wireless display interface or smart device like a smart tablet or smart phone with corresponding software implemented with a mobile application, though such wireless protocols as Bluetooth Low Energy or Wi-Fi communication advertisement.

An external storage devices or wireless data transmission can also be connected via wireless communication module 205a or serial communication port 205b for remote backup and access for integrating advanced data logging and fault detection capabilities to improve accuracy, efficiency, and reliability in agricultural material handling.

To facilitate data retrieval and analysis, the scale controller 210 is equipped with a communication controller 207 that supports multiple data transmission protocols, including CANBUS, RS232, and ISOBUS. Communication controller 207 enable seamless integration with (i) In-Cab Tractor Displays—Allowing operators to view real-time weight data without leaving the vehicle; (ii) Farm Management Software—Supporting automated tracking, inventory management, and logistics optimization; and (iii) Cloud-Based Data Storage—Enabling remote access, historical analysis, and predictive maintenance through wireless connectivity.

An AI module 201 may also be connected to microprocessor 202 allowing for even greater diagnostic capability as well as a compensatory function that could be implemented once a fault in load cell 203 is detected, which will be discussed in further detail below.

When storage carrier 101 is at rest, scale system 200 should also be stable, with output signals from load cells 203 remaining consistent. Scale controller 210 continuously monitors and analyzes fluctuations in the signals from each load cell 203, quantifying these variations over a defined period. By establishing a threshold value, microprocessor 202 of scale controller 210 classifies each load cell 203 as stable if fluctuations remain below the threshold or unstable if fluctuations exceed the threshold, indicating signal drift. Load cells 203 are highly sensitive and can detect minor expansions and contractions in metal caused by temperature changes. To account for these natural variations, minor fluctuations below the threshold are permitted. Microprocessor 202 continuously reanalyzes and updates the stability status of each load cell 203 during operation, ensuring accurate weight measurements and early detection of potential load cell malfunctions.

In a typical implementation, a scale system 200 utilizes three or more load cells 203 weighing portions of the same storage carrier 101. It can be extrapolated that when a sufficient number of the signals from load cells 203 are stable, scale system 200 must be stable. A sufficient number can be defined as n−1 where n represents the total number of load cells 203 in the system. For example, in a scale system 200 comprising of six load cells 203, n would equal six and n−1 would equal five, where five load cells 203 would be considered a super majority in this scale system 200 and five stable signals would be adequate to infer that storage carrier 101 is at rest and the the scale system 200 is stable or in a resting state. When scale system 200 is stable, all of the signals from load cells 203 should settle similarly as long as all components are operating correctly. In an example where all but one of the output signals from load cells 203 are stable for a predetermined period of time and the signal of the final load cell 203 remains continuously unstable, this behavior indicates that the unstable load cell 203 is likely to be malfunctioning due to the erratic output. Thus, the operator can quickly identify and replace the malfunctioning load cell 203. One skilled in the art will recognize that the more data scale system 200 has and the more intelligent scale system 200 becomes, the definition of “sufficient number” can decrease, e.g., even down to half n/2 of load cells 203. As such, stability could be determined when the plurality of load cells equals n and stability or rest state is determined when the analog output signal from x number of n load cells fluctuate below a threshold value, wherein n/2≤x≥n−1 (n/2 is less than or equal to x; and x is greater than or equal to n−1) and any value in between. Scale controller 210 can then identify the faulty load cell(s) 203 and communicate this fault to the operator of the system.

In a stable state, scale system 200 can detect load cells 203 that exhibit signal drift which is an early indicator of a malfunction. When load cell 203 has failed in such a way that its output signal is drifting, the voltage signal from load cell 203 will slowly increase or decrease over time. Again, a threshold value is established that accounts for thermal fluctuations, but above the threshold value for a predetermined period of time (typically within hours or less than 24 hours), output signal drift is indicative of a malfunction. When all signals from load cells 203 are stable, scale controller 210 can measure how much weight is lost or accumulated from each output signal and it corresponding load cell 203 while remaining stable. If the increase or decrease from one load cell 203 meets or exceeds a predetermined threshold, that load cell 203 can be identified as drifting. Scale controller 210 can then identify the faulty load cell 203 and communicate this fault to the operator 109 of scale system 200 for replacement.

In an embodiment, stability could be determined from an input originating outside scale system 200 to allow scale controller 210 to identify load cells 203 with drifting output signals. Such an external source for an input signal may come from a GPS module, accelerometer, tractor speed sensor indicating whether the grain cart is moving, a park or drive signal from the tractor indicating the tractor with connected storage carrier 101 is in motion or soon will be in motion. All of these are considered sources external to scale system 200, whereas ascertaining stability from output signals from load cells 203 is ascertaining stability strictly internal to scale system 200.

In an embodiment, microprocessor 202 can be viewed as a state machine with the following states:
STABLE_STATE: Scale system 200 is stationary or signals from a sufficient number of the load cells are stable.
MOTION_STATE: Scale system 200 is in motion.
FAULT_STATE: Scale system has a malfunctioning load cell due to excessive signal variation or drift while at rest.

Inputs (i.e., Triggers for State Changes) to microprocessor 202 can be, as follows:
External Motion Signal (EXT_MOTION): A signal from an external source (e.g., GPS, accelerometer, tractor speed sensor) indicating whether the mobile scale 101, thus the system is not stable is moving.
Load Cell Variability (LC_VAR): If the load cell signals fluctuate over a predefined threshold, the grain cart is inferred to be in motion. This corresponds to using sources internal to scale system 200 to ascertain stability.
Load Cell Drift (LC_DRIFT): A slow increase or decrease in a load cell's signal over time while in STABLE_STATE, indicating a faulty load cell.

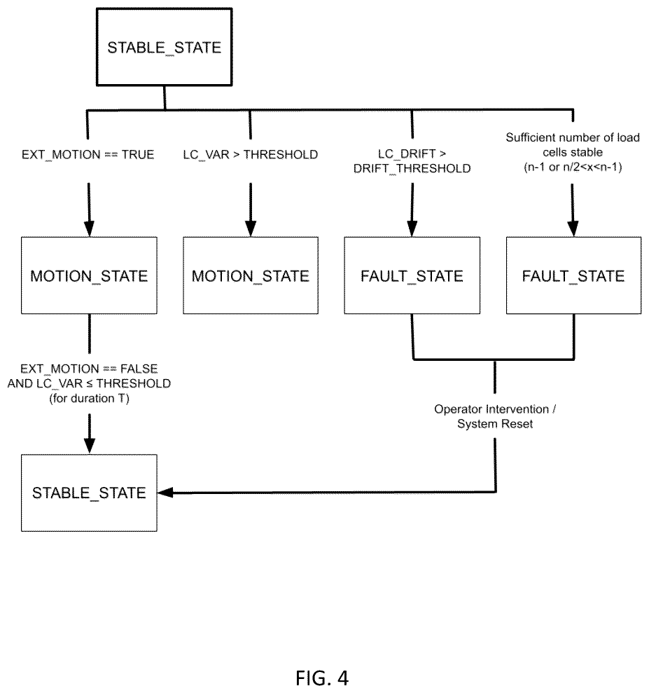

FIG. 4 shows a state diagram representation according to the following Table 1 incorporating the above definitions.

TABLE 1

| Current State | Input Condition | Next State | Action |
|---|---|---|---|
| STABLE_STATE | EXT_MOTION == | MOTION_STATE | Begin tracking |
| | TRUE | | motion |
| STABLE_STATE | LC_VAR > | MOTION_STATE | Transition to |
| | THRESHOLD | | motion state |
| STABLE_STATE | LC_DRIFT > | FAULT_STATE | Flag load cell |
| | DRIFT_THRESHOLD | | as faulty |
| | (for duration T) | | |
| STABLE_STATE | Sufficient number of | FAULT_STATE | Flag unstable |
| | load cells stable while | | load cell(s) |
| | others fluctuate | | as faulty |
| | (e.g., n − 1; or | | |
| | n/2 ≤ x ≥ n − 1) | | |
| MOTION_STATE | EXT_MOTION == | STABLE_STATE | Confirm cart |
| | FALSE AND | | is at rest |
| | LC_VAR ≤ | | |
| | THRESHOLD | | |
| | (for duration T) | | |

In another implementation, useful records and signal logs can be separated from less useful data generated when the vehicle on which load cells 203 are attached is in motion by filtering based on the stability status of the scale system 200. Signal logs generated by recording all digital values derived from output signals from load cells 203 as well as gross scale weight while scale system 200 is stable will demonstrate consistent relationships between the signals from load cells 203 and can be used for diagnostic purposes or to create data sets for machine learning by AI module 201.

AI module 201 can be triggered to collect data when scale system 200 is in a stable state to ensure storage carrier 101 is not in motion. As long as scale system 200 via microprocessor 202 is in the stable state, scale system 200 and all load cells 203 are determined to be operating correctly with no load cell faults being detected. In this state, data from the output signals of load cells 203 can be collected and analyzed by AI module 201. Once a load cell fault is detected and microprocessor 202 transitions to FAULT_STATE, advanced capabilities of AI module 201 can take over. Assuming enough historical data about the relationship of faulty load cell 203 to the other load cells 203 has been collected by AI module 201, AI Module 201 may, for example, generate a simulated output to replace that of the faulty load cell 203. This is especially useful during harvest when it may not be possible to halt the use of storage carrier 101 to replace the fault load cell 203. Microprocessor 202 could disable the input from the faulty load cell 203 and use a simulated output generated by AI module 201 to output a reasonable approximation of the load actually present on the faulty load cell 203. The ability of scale controller 210 to replace a faulty signal with a simulated one and generate a reasonably accurate load estimate is a great advantage over current electronic scale systems. An estimated load reading could help an operator to continue to use the scale system 200 in some manor until a repair can be made and the detected fault cleared.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. A scale system for a mobile storage carrier comprising:
a plurality of load cells operatively combined to the mobile storage carrier with each one of the plurality of load cells for detecting deformations in the mobile storage carrier corresponding to weight added or subtracted from the storage carrier, and each one of the plurality of load cells providing an analog output signal;
a multi-channel analog to digital converter (ADC), wherein each one of the plurality of load cells is communicatively coupled to one channel of the multi-channel ADC for converting the analog output signal to a digital output signal;
a microprocessor communicatively coupled to the multi-channel ADC to receive the digital output signal from each channel of the multi-channel ADC, wherein the microprocessor comprises the following states:
a motion state in which the mobile storage carrier is in motion;
a stable state in which the mobile storage carrier is not in motion; and
a fault state in which the mobile storage carrier is in a rest state and a drift greater than a threshold value is measured in at least one load cell of the plurality of load cells.

2. The scale system of claim 1, wherein the microprocessor determines a rest state based solely on variations in measurements of the plurality of load cells.

3. The scale system of claim 2, wherein the plurality of load cells equals n, and wherein the microprocessor determines the rest state when the analog output signal from x number of n load cells fluctuate below a threshold value.

4. The scale system of claim 3, wherein n/2≤x≥n−1.

5. The scale system of claim 4, wherein x=n−1.

6. The scale system of claim 1, wherein the microprocessor determines a rest state based on a signal from a source external to the scale system.

7. The scale system of claim 6, wherein the source external to the scale system is one chosen from a gps, velocity sensor, accelerometer, and a vehicle signal.

8. The scale system of claim 1, and further comprising an artificial intelligence (AI) module configured to collect and analyze date from the microprocessor, which data corresponds to the digital output signals from each of the plurality of load cells, when the microprocessor is in the stable state.

9. The scale system of claim 8, wherein when the microprocessor is in the fault state, the AI module is configured to generate and provide the microprocessor with a simulated signal to replace the digital output signal from one load cell of the plurality of load cells determined to be malfunctioning.

10. A method for detecting load cell faults in a scale system for a mobile storage carrier, the method comprising:
receiving, by a multi-channel analog-to-digital converter (ADC), an analog output signal from each of a plurality of load cells operatively combined with the mobile storage carrier;
converting, by the multi-channel ADC, each analog output signal to a corresponding digital output signal;
receiving, by a microprocessor communicatively coupled to the multi-channel ADC, the digital output signal from each of the plurality of load cells;
determining, by the microprocessor, whether the digital output signal from each of the plurality of load cells is stable, and, if so, entering a stable state, and, if not, entering a motion state inferring to the mobile storage carrier being in motion; and
transitioning, by the microprocessor, to a fault state following the stable state in response to determining by the microprocessor that the digital output signal of at least one of the plurality of load cells has a drift greater than a threshold.

11. The method of claim 10, wherein determining whether the mobile storage carrier is in the stable state is based solely on variations in measurements from the plurality of load cells.

12. The method of claim 11, wherein the plurality of load cells equals n, and wherein the microprocessor determines the stable state when the digital output signals from x load cells fluctuate below a predefined threshold, wherein n/2<x<n−1.

13. The method of claim 12, wherein x=n−1.

14. The method of claim 10, further comprising determining the stable state based on a signal from a source external to the scale system.

15. The method of claim 14, wherein the external source is selected from a GPS module, velocity sensor, accelerometer, or a vehicle system signal.

16. The method of claim 10, further comprising: collecting and analyzing, by an artificial intelligence (AI) module, data from the microprocessor corresponding to the digital output signals of each of the plurality of load cells when the microprocessor is in the stable state.

17. The method of claim 16, further comprising: generating, by the AI module, a simulated signal to replace the digital output signal from a malfunctioning load cell when the microprocessor is in the fault state; providing, by the AI module, the simulated signal to the microprocessor to enable continued weight measurement despite a detected load cell failure.

18. A scale controller communicatively couplable to a plurality of load cells on a mobile storage, the scale controller comprising:
a motion state based on fluctuating signals from the plurality of load cells;
a stable state based on stable signals from a sufficient number of the plurality of load cells, wherein fluctuating signals from the remaining load cells of the plurality of load cells is indicative of a malfunction in the remaining load cells; and
a fault state based on excessive drift of a signal from at least one of the plurality of load cells when the scale controller is in the stable state.

19. The scale controller of claim 18, wherein the scale controller transitions between the motion state, stable state, and fault state based on predefined conditions, comprising:
transitioning from the stable state to the motion state when an external motion signal is received indicating movement of the mobile storage or when fluctuating signals from the plurality of load cells exceed a predefined variability threshold;
transitioning from the motion state to the stable state when the external motion signal indicates that the mobile storage has stopped moving and the signals from the plurality of load cells remain stable below the predefined variability threshold for a predetermined duration;
transitioning from the stable state to the fault state when at least one of the plurality of load cells exhibits excessive drift beyond a predefined drift threshold while the scale controller is in the stable state;
transitioning from the stable state to the fault state when a sufficient number of the plurality of load cells remain stable while at least one other load cell exhibits fluctuating signals such that the number of stable load cells is greater than n/2 and less than n−1, where n represents a total number of the plurality of load cells; and
transitioning from the fault state to the stable state upon operator intervention or a system reset to clear the fault condition.
